(19) United States
(12) Patent Application Publication
(10) Pub. No.: US 2024/0283718 A1
(43) Pub. Date: Aug. 22, 2024

(54) FAST CALL RECOVERY BASED ON UPLINK RADIO LINK MONITOR

(71) Applicant: QUALCOMM Incorporated, San Diego, CA (US)

(72) Inventors: Ming YANG, San Diego, CA (US); Juan MONTOJO, San Diego, CA (US); Ozcan OZTURK, San Diego, CA (US); Kausik RAY CHAUDHURI, San Diego, CA (US); Mukesh Kumar MITTAL, San Diego, CA (US)

(21) Appl. No.: 18/442,013

(22) Filed: Feb. 14, 2024

Related U.S. Application Data
(60) Provisional application No. 63/485,421, filed on Feb. 16, 2023.

(51) Int. Cl. H04L 43/0811; H04L 5/00; H04W 72/1268; H04W 76/19; H04W 76/30

(52) U.S. Cl. CPC H04L 43/0811; H04L 5/0053; H04W 72/1268; H04W 76/19; H04W 76/30

(57) ABSTRACT

Method and apparatus to efficiently establish a fast call recovery based on an occurrence of an uplink radio link failure. The apparatus monitors for an uplink radio link failure condition between the UE and a network entity. The apparatus terminates a connection with the network entity based on a detection of the uplink radio link failure condition. The apparatus reestablishes a new connection on a same frequency or a different frequency with the network entity or a second network entity. The apparatus transmits an uplink radio link failure report with an uplink failure cause value based on the uplink radio link failure condition.

### CROSS REFERENCE TO RELATED APPLICATION(S)

This application claims the benefit of and priority to U.S. Provisional Application Ser. No. 63/485,421, entitled “Fast Call Recovery Based on Uplink Radio Link Monitor” and filed on Feb. 16, 2023, which is expressly incorporated by reference herein in its entirety.

### TECHNICAL FIELD

The present disclosure relates generally to communication systems, and more particularly, to a configuration to efficiently establish a call recovery based on an occurrence of an uplink radio link failure.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a user equipment (UE). The device may be a processor and/or a modem at a UE or the UE itself. The apparatus monitors for an uplink radio link failure condition between the UE and a network entity. The apparatus terminates a connection with the network entity based on a detection of the uplink radio link failure condition. The apparatus reestablishes a new connection with the network entity or a second network entity. The apparatus transmitting an uplink radio link failure report based on the uplink radio link failure condition.

In an aspect of the disclosure, a method, a computer-readable medium, and an apparatus are provided. The apparatus may be a device at a network node. The device may be a processor and/or a modem at a network node or the network node itself. The apparatus communicating with a user equipment (UE). The apparatus receives a request to release a connection with the UE, the request indicating a cause based on a detection of an uplink radio link failure condition.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a link imbalance between a UE and base station.

FIG. 5 is call flow diagram of signaling between a UE and a base station.

FIG. 6 is a flowchart of a method of wireless communication.

FIG. 7 is a flowchart of a method of wireless communication.

FIG. 8 is a diagram illustrating an example of a hardware implementation for an example apparatus and/or network entity.

FIG. 9 is a flowchart of a method of wireless communication.

FIG. 10 is a flowchart of a method of wireless communication.

FIG. 11 is a diagram illustrating an example of a hardware implementation for an example network entity.

### DETAILED DESCRIPTION

In wireless communications, uplink quality may be very poor or degraded while the downlink quality is strong. In such instances, networks may have a low-band as a fallback option to address situations where the uplink quality is much less than the downlink quality. In instances where uplink quality is poor in comparison to the downlink quality, uplink radio link failures may occur, but the triggering of such uplink based radio link failure (RLF) may take an extended period of time that may impact the user experience. The UE may not be aware of the uplink based RLF for some time until the UE detects the reception of an unusual number of downlink packet duplicates. The network may eventually detect the uplink issue, but may also involve an extended period of time.

Aspects presented herein provide a configuration to efficiently establish a fast call recovery based on an occurrence of an uplink radio link failure. At least one advantage of the disclosure is that a UE may terminate a connection with the network and reestablish a new connection with the network based on a detection of an uplink RLF failure condition.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

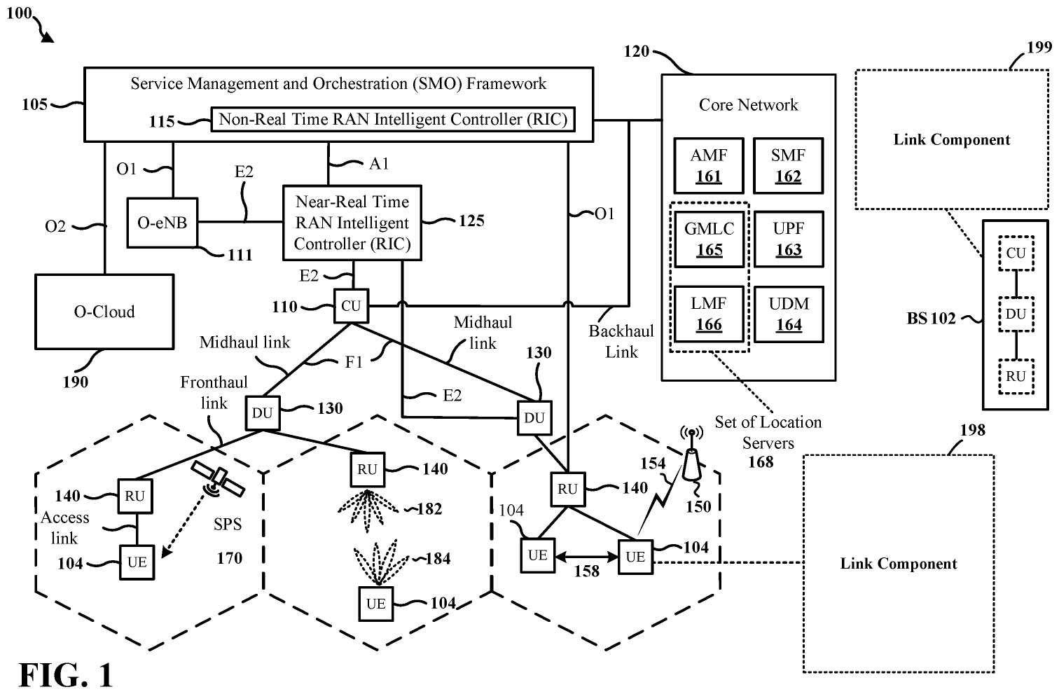

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a link component 198 configured to monitor for an uplink radio link failure condition between the UE and a network entity; terminate a connection with the network entity based on a detection of the uplink radio link failure condition; reestablish a new connection with the network entity or a second network entity; and transmit an uplink radio link failure report based on the uplink radio link failure condition.

Referring again to FIG. 1, in certain aspects, the base station 102 may include a link component 199 configured to communicate with a UE; and receive a request to release a connection with the UE, the request indicating a cause based on a detection of an uplink radio link failure condition.

Although the following description may be focused on 5G NR, the concepts described herein may be applicable to other similar areas, such as LTE, LTE-A, CDMA, GSM, and other wireless technologies.

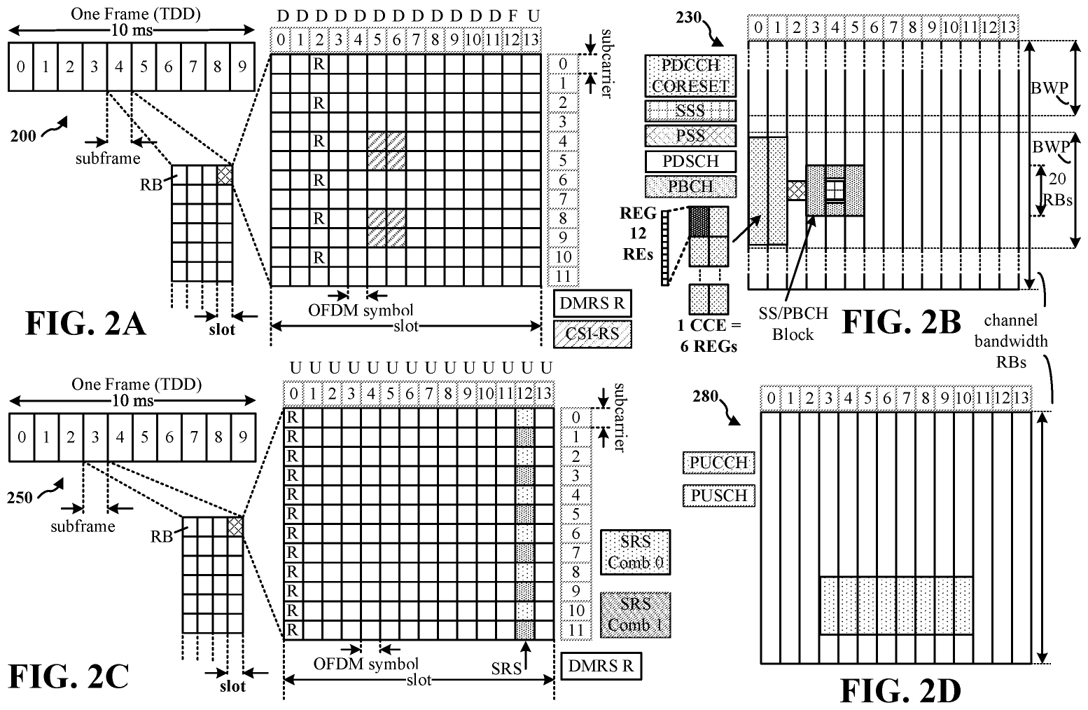

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} ·15[kHz] | prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 μs, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

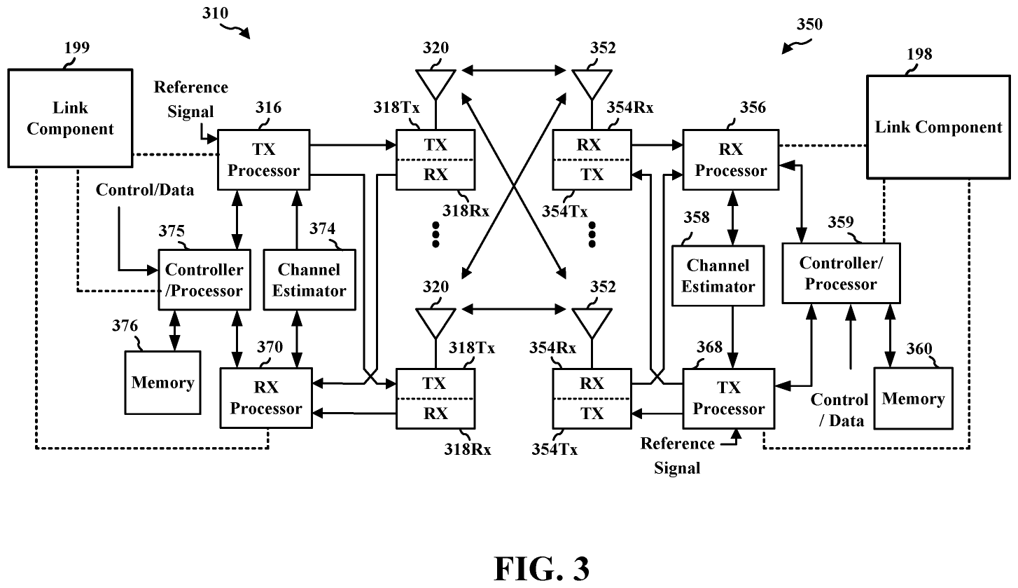

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the link component 198 of FIG. 1.

At least one of the TX processor 316, the RX processor 370, and the controller/processor 375 may be configured to perform aspects in connection with the link component 199 of FIG. 1.

In wireless communications, uplink quality may be very poor or degraded while the downlink quality is strong. Examples of such link imbalances may occur in dense or urban environments (e.g., deep indoor settings) or due to high uplink interference. In such instances, networks may have a low-band as a fallback option to address situations where the uplink quality is much less than the downlink quality.

In instances where uplink quality is poor in comparison to the downlink quality, uplink radio link failures may occur, but the triggering of such uplink based RLF may take an extended period of time that may impact the user experience. For example, at least one of the follow may occur in order to trigger the uplink based radio link failure: a maximum number of radio link control (RLC) retransmissions, random access channel (RACH) failure, or expiration of timing advance (TA) timer(s).

In such instances, a UE does not report RLF and does not initiate RRC re-establishment onto another frequency (e.g., frequency division duplex (FDD). The UE may not be aware of the uplink based RLF for some time until the UE detects the reception of an unusual number of downlink packet duplicates. The network may eventually detect the uplink issue, but may also involve an extended period of time due in part to the occurrence of at least one of a maximum number of radio link control (RLC) retransmissions, random access channel (RACH) failure, or expiration of timing advance (TA) timer(s). The occurrence of at least one of these may take an extended period of time for the user to re-initiate a call or connection, which may impact the user experience.

Aspects presented herein provide a configuration to efficiently establish a fast call recovery based on an occurrence of an uplink radio link failure. At least one advantage of the disclosure is that a UE may terminate a connection with the network and reestablish a new connection with the network based on a detection of an uplink RLF failure condition. A UE may be configured for a quick call recover based on uplink radio link monitoring in an effort to enhance the user experience.

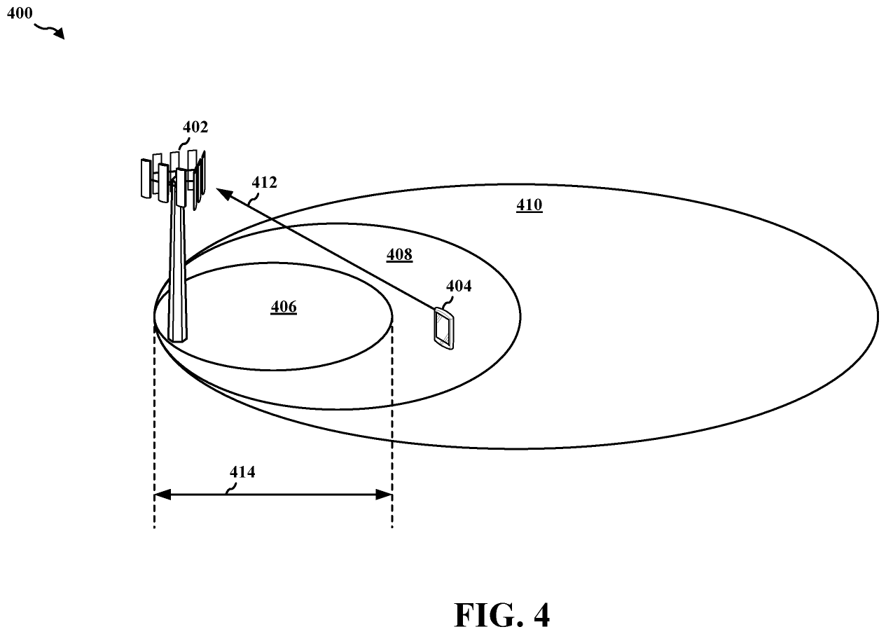

FIG. 4 illustrates a diagram 400 of a link imbalance between a UE and a base station. The diagram 400 includes a base station 402 and a UE 404. The base station 402 may include a high band system 406 (e.g., millimeter wave (mmW TDD uplink)), a mid band system 408 (e.g., mmW TDD downlink), and a low band system 410 (e.g., FDD). A UE within a footprint 414 of the high band system 406 will have coverage with a balanced uplink and downlink. A UE within the coverage of the mid band system 408 will have a good downlink coverage under the mid band system 408, but uplink coverage may be impacted or poor, such that there is an imbalance between the uplink and downlink when the UE is within the mid band system 408. The uplink and downlink imbalance may result in a prolonged or extended period of time before a radio link failure occurs.

In some aspects, the UE 404 may detect that the uplink is poor or broken. The uplink may be poor or broken due to at least one of duplicated PDSCH retransmissions, uplink data stall, poor user experience, a lack of uplink grants after scheduling request (SR) transmissions, activation or deactivation of connected mode discontinuous reception (C-DRX), a mismatch between the active BWP between the UE and the network, or the like. In such instances, severe link imbalance is present between the UE and the network.

In instances where sever link imbalance is detected with low or poor uplink quality, the UE may initiate an RRC reestablishment procedure or the UE may request a call release (e.g., 412) with a new cause value of the uplink issue and a desired redirection or handover. The release cause may include at least one of duplicated physical downlink shared channel (PDSCH) retransmissions due to an acknowledgement (ACK) mis-detected as non-acknowledgement (NACK) on uplink; uplink traffic data stall in a UE buffer; a number of RLC segmentation, a number of uplink slots for uplink slot aggregation, single transport block over multiple uplink slots greater than a threshold; a voice codec rate/video resolution less than a threshold; transmission power imbalance crossing multiple transmit antennas greater than a threshold; time of successfully delivering downlink RLC status packet data units (PDU), MAC-CE power headroom greater than a threshold, transmission of scheduling request until the uplink grant. These are non-limiting examples of the release cause, and the disclosure is not intended to be limited to such examples, such that other events or occurrences may lead to or be related to the release cause.

The UE may then perform a scan for at least one of a public land mobile network (PLMN), a RAT, or frequency to reestablish a connection. In some aspects, after the connection has been reestablished, the UE may re-initiate the call setup. In some aspects, the network may provide an indication to the UE to handover or redirection to another network (e.g., RAT or low band system 410) or frequency to reestablish the connection.

Upon the connection being reestablished, the UE may provide an uplink RLF report to the network (e.g., base station). The uplink RLF report may include the cause of the uplink RLF. In some aspects, the uplink RLF report may be included within a minimization of drive test (MDT). In some aspects, the network may provide the UE with a request for the uplink RLF report. The UE may provide the uplink RLF report in response to the request for the uplink RLF report or in the absence of the request for the uplink RLF report.

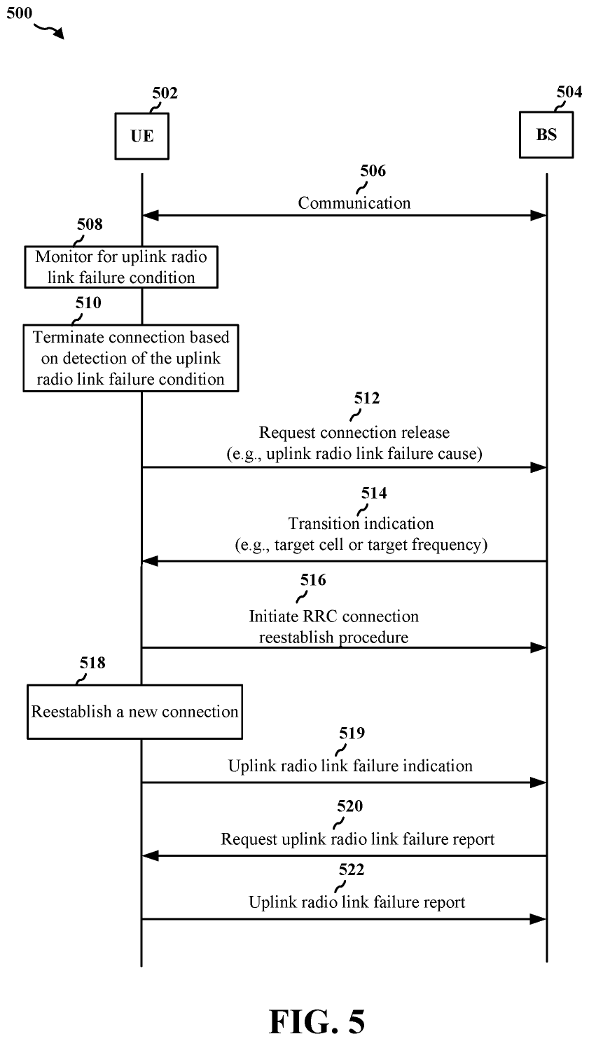

FIG. 5 is a call flow diagram 500 of signaling between a UE 502 and a base station 504. The base station 504 may be configured to provide at least one cell. The UE 502 may be configured to communicate with the base station 504. For example, in the context of FIG. 1, the base station 504 may correspond to base station 102 and the UE 502 may correspond to at least UE 104. In another example, in the context of FIG. 3, the base station 504 may correspond to base station 310 and the UE 502 may correspond to UE 350.

At 506, the UE 502 and the base station 504 may communicate with each other.

At 508, the UE 502 may monitor for an uplink radio link failure condition between the UE and a network entity. The uplink radio link failure condition includes at least one of duplicated physical downlink shared channel (PDSCH) retransmissions due to an acknowledgement (ACK) mis-detected as non-acknowledgement (NACK) on uplink; uplink traffic data stall in a UE buffer; transmission of a first timing difference between multiple transmit antennas; transmission of a second timing difference between uplink component carriers having a similar or same timing advance group; uplink radio link control (RLC) status stall in the UE buffer; uplink medium access control (MAC) control element (CE) (MAC-CE) stall in the UE buffer; uplink or downlink link imbalance; uplink traffic quality of service (QoS) below a threshold; lack of receipt of an uplink grant in response to a scheduling request transmission transmitted one or more times with a maximum UE transmission power; a first detected or suspected mismatch of a C-DRX between the UE and the network entity detected by the UE; or a second detected or suspected mismatch of an active bandwidth part (BWP) between the UE and the network entity detected by the UE.

At 510, the UE 502 may terminate a connection with the base station 504. The UE may terminate the connection with the base station 504 based on a detection of the uplink radio link failure condition. In some aspects, the UE may terminate the connection with the base station with or without sending a release request.

For example, at 512, the UE 502, to terminate the connection based on the detection of the uplink radio failure condition, may request a connection release. The connection release may indicate a cause based on the detection of an uplink radio link failure cause value. In some aspects, the UE may terminate the connection with or without sending the connection release.

At 514, the base station 504 may provide an indication to transition to a target cell or a target frequency. The UE 502 may receive the indication to transition to the target cell or the target frequency from the base station 504. The base station 504 may provide the indication to transition to the target cell or the target frequency to establish the new connection in response to the request for the connection release. The UE may receive the indication to transition to the target cell or the target frequency to establish the new connection, in response to requesting the connection release. In some aspects, the base station does not provide the indication to transition to the target cell or the target frequency. For example, the base station may not provide the indication to transition in instances where poor or degraded uplink is present, such that the base station may not have properly received the connection release from the UE.

In another example, at 516, the UE 502, to terminate the connection based on the detection of the uplink radio failure condition, may initiate an RRC connection reestablishment procedure. The UE may initiate the RRC connection reestablishment procedure with or without receiving an indication, from the base station, to transition to a target cell or a target frequency. In some aspects, the UE may initiate the RRC connection reestablishment procedure in instances where severe link imbalance is detected by the UE with low uplink quality.

At 518, the UE 502 may reestablish a new connection. The UE 502 may reestablish the new connection with the base station 504 or a second base station (not shown). The UE may reestablish the new connection on a same or a different frequency than that of the frequency utilized for an original connection. In some aspects, the UE may reestablish the new connection with a second base station (not shown) if the original base station (e.g., base station 504) is unavailable or has a weaker signal strength or quality than the second base station (not shown).

In some aspects, for example at 519, the UE 502 may transmit an uplink radio link failure indication to the base station 504. The base station 504 may obtain the uplink radio link failure indication from the UE 502. The uplink radio link failure indication may be transmitted to a second cell of the base station 504. For example, in some aspects, the second cell of the base station 504 may operate in a second frequency range that is different from that of the first cell, which the UE had requested the connection release. In some aspects, the second cell of the base station may operate in a different RAT that has reliable uplink. The uplink radio link failure indication may indicate to the second cell of the base station that the UE has uplink issues and/or failures and would like to establish a connection on the second cell of the base station. In such instances, the UE may autonomously terminate the connection with the first cell of the base station and establish a new connection on the second cell of the base station.

At 520, the base station 504 may provide a request for the uplink radio link failure report based on the uplink radio link failure indication. The base station 504 may provide the request for the uplink radio link failure report to the UE 502. The UE 502 may receive the request for the uplink radio link failure report based on the uplink radio link failure indication.

At 522, the UE 502 may transmit an uplink radio link failure report. The UE may transmit the uplink radio link failure report to the base station 504. The base station 504 may obtain the uplink radio link failure report from the UE 502. The UE may transmit the uplink radio link failure report with an uplink failure cause value based on the uplink radio link failure condition. The uplink radio link failure report may include an uplink failure cause value. The uplink failure cause value may correspond to at least one uplink radio link failure condition. In some aspects, the uplink radio link failure report may be included within a MDT and may indicate an uplink radio link failure cause per network request during or after RRC re-establishment. In some aspects, the UE may transmit the uplink radio link failure report in response to a request, from the network entity, for the uplink radio link failure report.

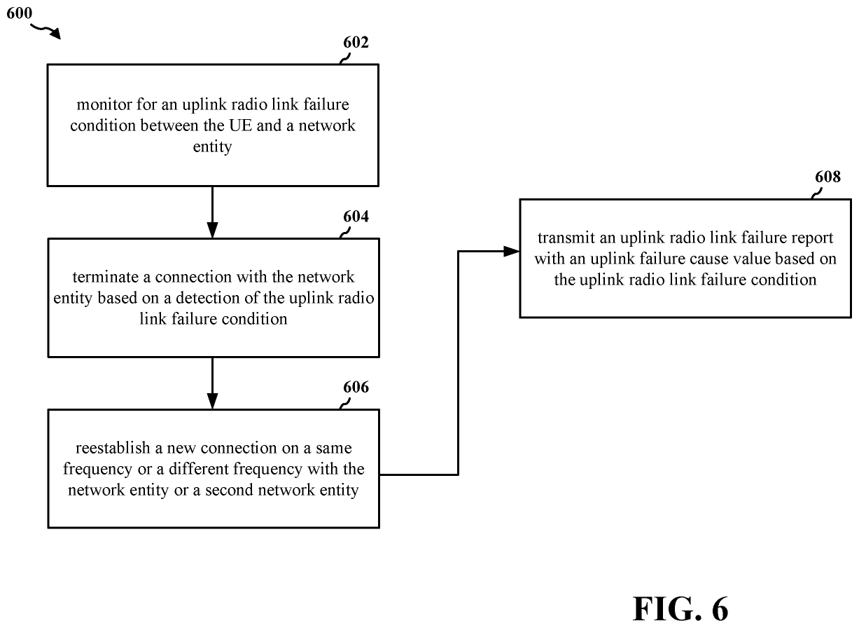

FIG. 6 is a flowchart 600 of a method of wireless communication. The method may be performed by a UE (e.g., the UE 104; the apparatus 804). One or more of the illustrated operations may be omitted, transposed, or contemporaneous. The method may configure a UE to terminate a connection with a network and reestablish a new connection with the network based on a detection of an uplink RLF failure condition.

At 602, the UE may monitor for an uplink radio link failure condition. For example, 602 may be performed by link component 198 of apparatus 804. The UE may monitoring for the uplink radio link failure condition between the UE and a network entity. The uplink radio link failure condition includes at least one of duplicated PDSCH retransmissions due to an ACK mis-detected as NACK on uplink; uplink traffic data stall in a UE buffer; transmission of a first timing difference between multiple transmit antennas; transmission of a second timing difference between uplink component carriers having a similar or same timing advance group; uplink RLC status stall in the UE buffer; uplink MAC-CE stall in the UE buffer; uplink or downlink link imbalance; uplink traffic QoS below a threshold; lack of receipt of an uplink grant in response to a scheduling request transmission transmitted one or more times with a maximum UE transmission power; a first detected or suspected mismatch of a C-DRX between the UE and the network entity detected by the UE; or a second detected or suspected mismatch of an active BWP between the UE and the network entity detected by the UE.

At 604, the UE may terminate a connection with the network entity. For example, 604 may be performed by link component 198 of apparatus 804. The UE may terminate the connection with the network entity based on a detection of the uplink radio link failure condition. In some aspects, the UE may terminate the connection with the network entity with or without sending a release request.

At 606, the UE may reestablish a new connection. For example, 606 may be performed by link component 198 of apparatus 804. The UE may reestablish the new connection with the network entity or a second network entity. The UE may reestablish the new connection on a same or a different frequency than that of the frequency of the original connection. In some aspects, the UE may reestablish the new connection with a second network entity if the original network entity is unavailable or has a weaker signal strength or quality than the second network entity.

At 608, the UE may transmit an uplink radio link failure report. For example, 608 may be performed by link component 198 of apparatus 804. The UE may transmit the uplink radio link failure report based with an uplink failure cause value on the uplink radio link failure condition. The uplink radio link failure report may include an uplink failure cause value. The uplink failure cause value may correspond to at least one uplink radio link failure condition. In some aspects, the uplink radio link failure report may be included within a MDT and may indicate an uplink radio link failure cause per network request during or after RRC re-establishment. In some aspects, the UE may transmit the uplink radio link failure report in response to a request, from the network entity, for the uplink radio link failure report.

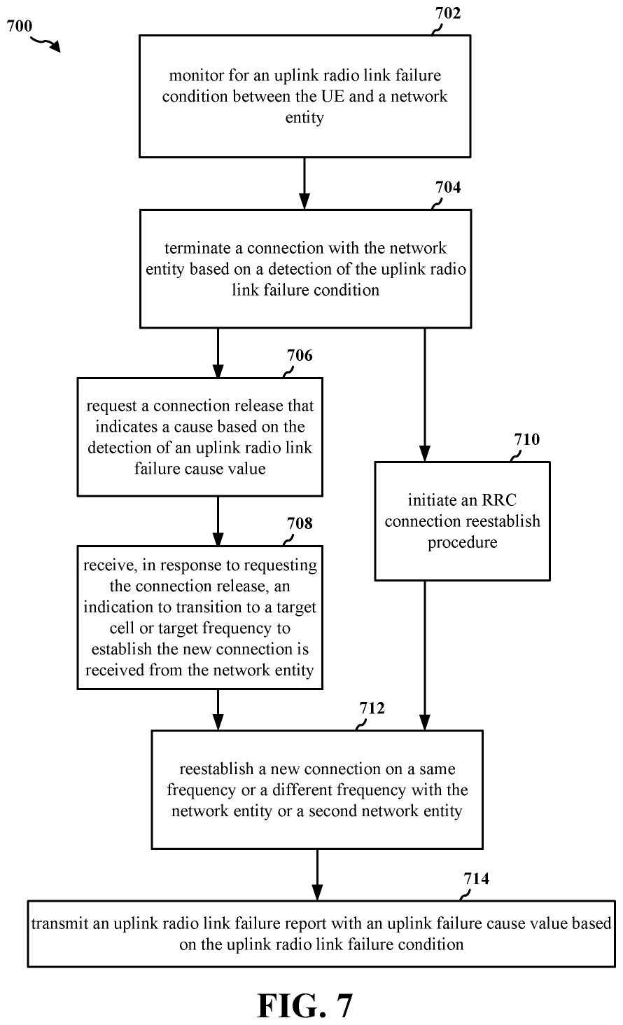

FIG. 7 is a flowchart 700 of a method of wireless communication. The method may be performed by a UE (e.g., the UE 104; the apparatus 804). One or more of the illustrated operations may be omitted, transposed, or contemporaneous. The method may configure a UE to terminate a connection with a network and reestablish a new connection with the network based on a detection of an uplink RLF failure condition.

At 702, the UE may monitor for an uplink radio link failure condition. For example, 702 may be performed by link component 198 of apparatus 804. The UE may monitoring for the uplink radio link failure condition between the UE and a network entity. The uplink radio link failure condition includes at least one of duplicated PDSCH retransmissions due to an ACK mis-detected as NACK on uplink; uplink traffic data stall in a UE buffer; transmission of a first timing difference between multiple transmit antennas; transmission of a second timing difference between uplink component carriers having a similar or same timing advance group; uplink RLC status stall in the UE buffer; uplink MAC-CE stall in the UE buffer; uplink or downlink link imbalance; uplink traffic QoS below a threshold; lack of receipt of an uplink grant in response to a scheduling request transmission transmitted one or more times with a maximum UE transmission power; a first detected or suspected mismatch of a C-DRX between the UE and the network entity detected by the UE; or a second detected or suspected mismatch of an active bandwidth part (BWP) between the UE and the network entity detected by the UE.

At 704, the UE may terminate a connection with the network entity. For example, 704 may be performed by link component 198 of apparatus 804. The UE may terminate the connection with the network entity based on a detection of the uplink radio link failure condition. In some aspects, the UE may terminate the connection with the network entity with or without sending a release request.

At 706, the UE, to terminate the connection based on the detection of the uplink radio failure condition, may request a connection release. For example, 706 may be performed by link component 198 of apparatus 804. The connection release may indicate a cause based on the detection of an uplink radio link failure cause value. In some aspects, the UE may terminate the connection with or without sending the connection release.

At 708, the UE may receive an indication to transition to a target cell or target frequency. For example, 708 may be performed by link component 198 of apparatus 804. The UE may receive an indication to transition to the target cell or the target frequency to establish the new connection from the network entity. The UE may receive the indication to transition to the target cell or the target frequency to establish the new connection, in response to requesting the connection release. In some aspects, the UE may not receive the indication to transition to the target cell or the target frequency. For example, the base station may not provide, to the UE, the indication to transition in instances where poor or degraded uplink is present, such that the base station may not have properly received the connection release from the UE.

At 710, the UE, to terminate the connection based on the detection of the uplink radio failure condition, may initiate an RRC connection reestablishment procedure. For example, 710 may be performed by link component 198 of apparatus 804. In some aspects, the UE may initiate the RRC connection reestablishment procedure in instances where severe link imbalance is detected by the UE with low uplink quality. In some aspects, the UE may initiate the RRC connection reestablishment procedure with or without receiving an indication to transition to a target cell or a target frequency from the network entity. For example, the UE may not receive the indication to transition to a target cell or target frequency, in response to the connection release request, due in part to poor or low uplink quality, such that the UE may initiate the RRC connection reestablishment procedure. However, in some aspects, the UE may initiate the RRC connection reestablishment procedure without transmitting a connection release request.

At 712, the UE may reestablish a new connection. For example, 712 may be performed by link component 198 of apparatus 804. The UE may reestablish the new connection with the network entity or a second network entity. The UE may reestablish the new connection on a same or a different frequency than that of the frequency of the original connection. In some aspects, the UE may reestablish the new connection with a second network entity if the original network entity is unavailable or has a weaker signal strength or quality than the second network entity. In some aspects, the UE may transmit an uplink radio link failure indication to the network entity. The uplink radio link failure indication may be transmitted to a second cell of the network entity. For example, in some aspects, the second cell of the network entity may operate in a second frequency range that is different from that of the first cell of the network entity, which the UE had requested the connection release. In some aspects, the second cell of the network entity may operate in a different RAT that has reliable uplink. The uplink radio link failure indication may indicate to the second cell of the network entity that the UE has uplink issues and/or failures and would like to establish a connection on the second cell of the network entity. In such instances, the UE may autonomously terminate the connection with the first cell of the network entity and establish a new connection on the second cell of the network entity.

At 714, the UE may transmit an uplink radio link failure report. For example, 714 may be performed by link component 198 of apparatus 804. The UE may transmit the uplink radio link failure report with an uplink failure case value based on the uplink radio link failure condition. The uplink radio link failure report may include an uplink failure cause value. The uplink failure cause value may correspond to at least one uplink radio link failure condition. In some aspects, the uplink radio link failure report may be included within a MDT and may indicate an uplink radio link failure cause per network request during or after RRC re-establishment. In some aspects, the UE may transmit the uplink radio link failure report in response to a request, from the network entity, for the uplink radio link failure report.

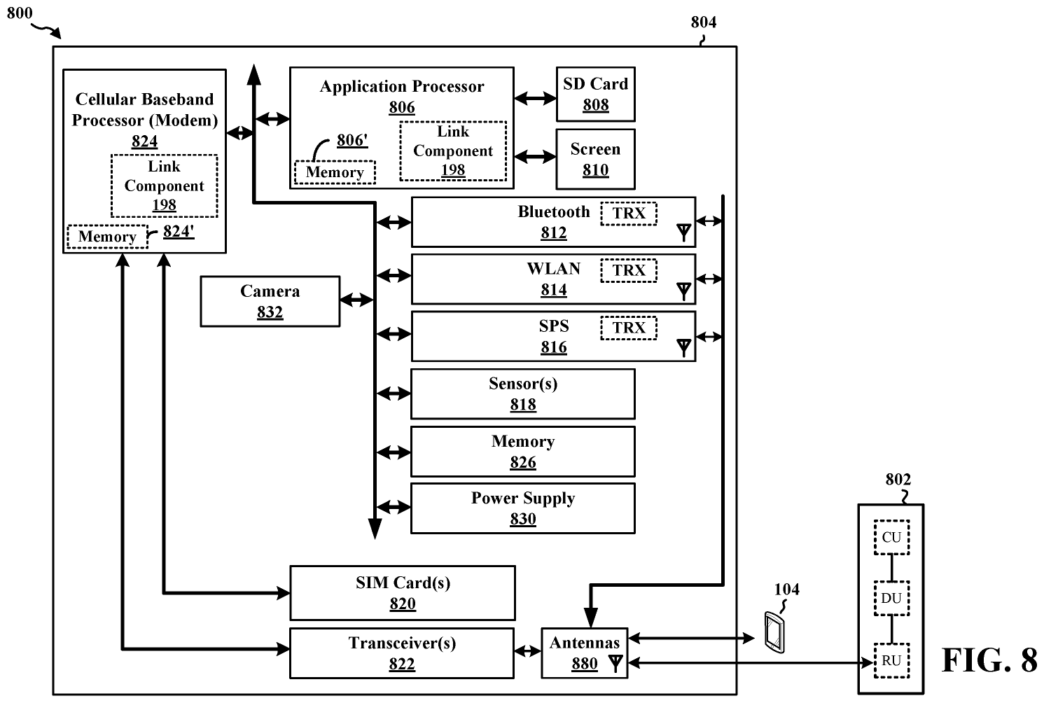

FIG. 8 is a diagram 800 illustrating an example of a hardware implementation for an apparatus 804. The apparatus 804 may be a UE, a component of a UE, or may implement UE functionality. In some aspects, the apparatus 804 may include at least one cellular baseband processor 824 (also referred to as a modem) coupled to one or more transceivers 822 (e.g., cellular RF transceiver). The cellular baseband processor(s) 824 may include on-chip memory 824′. In some aspects, the apparatus 804 may further include one or more subscriber identity modules (SIM) cards 820 and an application processor 806 coupled to a secure digital (SD) card 808 and a screen 810. The application processor 806 may include at least one on-chip memory 806′. In some aspects, the apparatus 804 may further include a Bluetooth module 812, a WLAN module 814, an SPS module 816 (e.g., GNSS module), one or more sensor modules 818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 826, a power supply 830, and/or a camera 832. The Bluetooth module 812, the WLAN module 814, and the SPS module 816 may include an on-chip transceiver (TRX) (or in some cases, just a receiver (RX)). The Bluetooth module 812, the WLAN module 814, and the SPS module 816 may include their own dedicated antennas and/or utilize the antennas 880 for communication. The cellular baseband processor(s) 824 communicate through the transceiver(s) 822 via one or more antennas 880 with the UE 104 and/or with an RU associated with a network entity 802. The cellular baseband processor(s) 824 and the application processor(s) 806 may each include a computer-readable medium/memory 824′, 806′, respectively. The additional memory modules 826 may also be considered a computer-readable medium/memory. Each computer-readable medium/memory 824′, 806′, 826 may be non-transitory. The cellular baseband processor 824 and the application processor 806 are each responsible for general processing, including the execution of software stored on the computer-readable medium/memory. The software, when executed by the cellular baseband processor 824/application processor 806, causes the cellular baseband processor 824/application processor 806 to perform the various functions described supra. The cellular baseband processor(s) 824 and the application processor(s) 806 are configured to perform the various functions described supra based at least in part of the information stored in the memory. That is, the cellular baseband processor(s) 824 and the application processor(s) 806 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 824/application processor(s) 806 when executing software. The cellular baseband processor(s) 824/application processor(s) 806 may be a component of the UE 350 and may include the at least one memory 360 and/or at least one of the TX processor 368, the RX processor 356, and the controller/processor 359. In one configuration, the apparatus 804 may be at least one processor chip (modem and/or application) and include just the cellular baseband processor(s) 824 and/or the application processor(s) 806, and in another configuration, the apparatus 804 may be the entire UE (e.g., see 350 of FIG. 3) and include the additional modules of the apparatus 804.

As discussed supra, the component 198 may be configured to monitor for an uplink radio link failure condition between the UE and a network entity; terminate a connection with the network entity based on a detection of the uplink radio link failure condition; reestablish a new connection on a same frequency or a different frequency with the network entity or a second network entity; and transmit an uplink radio link failure report with an uplink failure cause value based on the uplink radio link failure condition. The component 198 may be within the cellular baseband processor(s) 824, the application processor(s) 806, or both the cellular baseband processor(s) 824 and the application processor(s) 806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 804 may include a variety of components configured for various functions. In one configuration, the apparatus 804, and in particular the cellular baseband processor 824 and/or the application processor 806, includes means for monitoring for an uplink radio link failure condition between the UE and a network entity. The apparatus includes means for terminating a connection with the network entity based on a detection of the uplink radio link failure condition. The apparatus includes means for reestablishing a new connection on a same frequency or a different frequency with the network entity or a second network entity. The apparatus includes means for transmitting an uplink radio link failure report with an uplink failure cause value based on the uplink radio link failure condition. The apparatus further includes means for requesting a connection release that indicates a cause based on the detection of an uplink radio link failure cause value. The apparatus further includes means for receiving, in response to requesting the connection release, an indication to transition to a target cell or target frequency to establish the new connection is received from the network entity. The apparatus further includes means for initiating a RRC connection reestablishment procedure with or without receiving an indication to transition to a target cell or a target frequency. The means may be the component 198 of the apparatus 804 configured to perform the functions recited by the means. As described supra, the apparatus 804 may include the TX processor 368, the RX processor 356, and the controller/processor 359. As such, in one configuration, the means may be the TX processor 368, the RX processor 356, and/or the controller/processor 359 configured to perform the functions recited by the means.

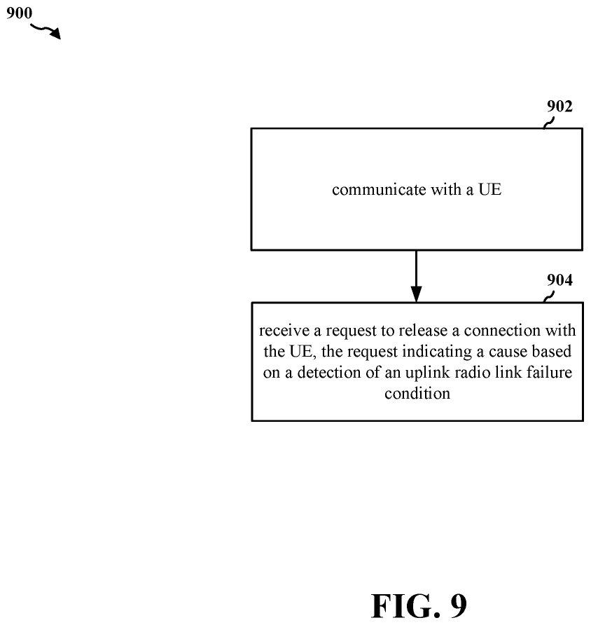

FIG. 9 is a flowchart 900 of a method of wireless communication. The method may be performed by a base station (e.g., the base station 102; the network entity 1102. One or more of the illustrated operations may be omitted, transposed, or contemporaneous. The method may configure a UE to terminate a connection with a network and reestablish a new connection with the network based on a detection of an uplink RLF failure condition.

At 902, the base station may communicate with a UE. For example, 902 may be performed by link component 199 of network entity 1102.

At 904, the base station may receive a request to release a connection with the UE. For example, 904 may be performed by link component 199 of network entity 1102. The request may indicate a cause based on a detection of an uplink radio link failure condition. In some aspects, the uplink radio link failure condition includes at least one of duplicated PDSCH retransmissions due to an ACK mis-detected as a NACK on uplink; uplink traffic data stall in a UE buffer; transmission of a first timing difference between multiple transmit antennas; transmission of a second timing difference between uplink component carriers having a similar or same timing advance group; uplink RLC status stall in the UE buffer; uplink MAC-CE stall in the UE buffer; uplink or downlink link imbalance; uplink traffic QoS below a threshold; lack of receipt of an uplink grant in response to a scheduling request transmission transmitted one or more times with a maximum UE transmission power; a first detected or suspected mismatch of a C-DRX between the UE and the network entity detected by the UE; or a second detected or suspected mismatch of an active BWP between the UE and the network entity detected by the UE.

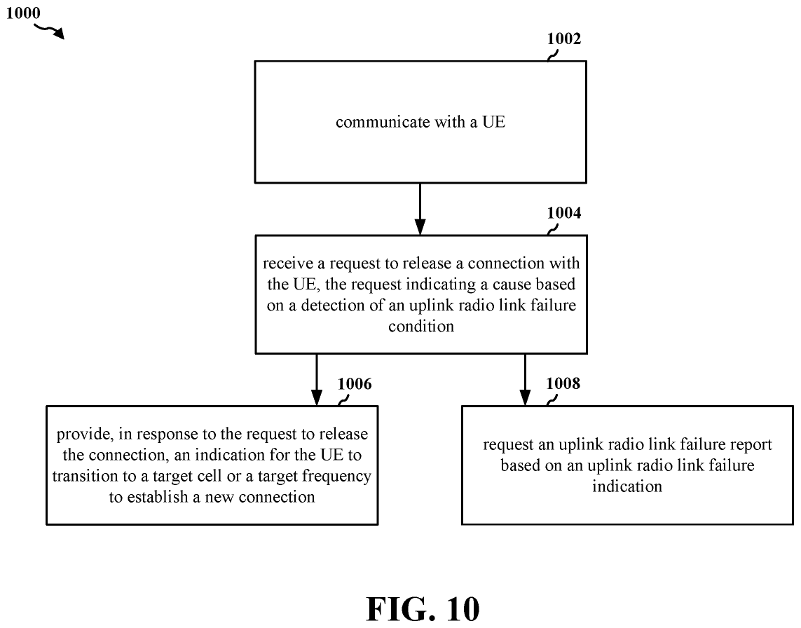

FIG. 10 is a flowchart 1000 of a method of wireless communication. The method may be performed by a base station (e.g., the base station 102; the network entity 1102. One or more of the illustrated operations may be omitted, transposed, or contemporaneous. The method may configure a UE to terminate a connection with a network and reestablish a new connection with the network based on a detection of an uplink RLF failure condition.

At 1002, the base station may communicate with a UE. For example, 1002 may be performed by link component 199 of network entity 1102.

At 1004, the base station may receive a request to release a connection with the UE. For example, 1004 may be performed by link component 199 of network entity 1102. The request may indicate a cause based on a detection of an uplink radio link failure condition. In some aspects, the uplink radio link failure condition includes at least one of duplicated PDSCH retransmissions due to an ACK mis-detected as a NACK on uplink; uplink traffic data stall in a UE buffer; transmission of a first timing difference between multiple transmit antennas; transmission of a second timing difference between uplink component carriers having a similar or same timing advance group; uplink RLC status stall in the UE buffer; uplink MAC-CE stall in the UE buffer; uplink or downlink link imbalance; uplink traffic QoS below a threshold; lack of receipt of an uplink grant in response to a scheduling request transmission transmitted one or more times with a maximum UE transmission power; a first detected or suspected mismatch of a C-DRX between the UE and the network entity detected by the UE; or a second detected or suspected mismatch of an active BWP between the UE and the network entity detected by the UE.

At 1006, the base station may provide an indication for the UE to transition to a target cell or a target frequency. For example, 1006 may be performed by link component 199 of network entity 1102. The base station may provide the indication for the UE to transition to the target cell or the target frequency to establish a new connection. The station may provide the indication for the UE to transition to the target cell or the target frequency to establish a new connection, in response to the request to release the connection from the UE.

At 1008, the base station may request an uplink radio link failure report. For example, 1008 may be performed by link component 199 of network entity 1102. The base station may request the uplink radio link failure report from the UE. The base station may request the uplink radio link failure report based on an uplink radio link failure indication from the UE. For example, the request indicating the cause of the detection of the uplink radio link failure condition may include the uplink radio link failure indication. In some aspects, the uplink radio link failure report is included within a MDT and indicates an uplink radio link failure cause value.

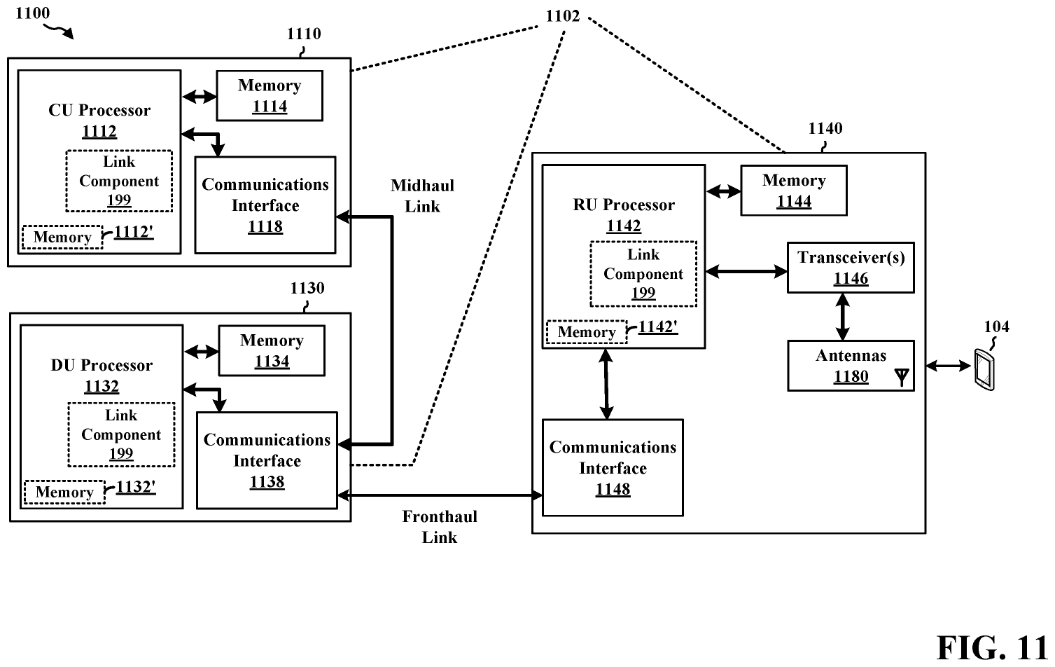

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor 1112. The CU processor(s) 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor 1132. The DU processor(s) 1132 may include on-chip memory 1132′. In some aspects, the DU 1130 may further include additional memory modules 1134 and a communications interface 1138. The DU 1130 communicates with the RU 1140 through a fronthaul link. The RU 1140 may include at least one RU processor 1142. The RU processor(s) 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to communicate with a UE; and receive a request to release a connection with the UE, the request indicating a cause based on a detection of an uplink radio link failure condition. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 includes means for communicating with a UE. The network entity includes means for receiving a request to release a connection with the UE, the request indicating a cause based on a detection of an uplink radio link failure condition. The network entity further includes means for providing, in response to the request to release the connection, an indication for the UE to transition to a target cell or a target frequency to establish a new connection. The network entity further includes means for requesting an uplink radio link failure report based on an uplink radio link failure indication. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

Aspects presented herein provide a configuration to efficiently establish a fast call recovery based on an occurrence of an uplink radio link failure. A UE may be configured to monitor for an uplink RLF condition between a UE and a network entity. The UE may terminate the connection and reestablish a new connection based on a detection of the uplink RLF condition. The UE may transmit an uplink RLF report after the new connection has been reestablished. At least one advantage of the disclosure is that a UE may terminate a connection with the network and reestablish a new connection with the network based on a detection of an uplink RLF failure condition. At least another advantage is that the UE may be configured for a quick call recover based on uplink radio link monitoring in an effort to enhance the user experience.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising monitoring for an uplink radio link failure condition between the UE and a network entity; terminating a connection with the network entity based on a detection of the uplink radio link failure condition; reestablishing a new connection on a same frequency or a different frequency with the network entity or a second network entity; and transmitting an uplink radio link failure report with an uplink failure cause value based on the uplink radio link failure condition.

Aspect 2 is the method of aspect 1, further includes that the uplink radio link failure condition comprises at least one of duplicated PDSCH retransmissions due to an ACK mis-detected as NACK on uplink; uplink traffic data stall in a UE buffer; transmitting a first timing difference between multiple transmit antennas; transmitting a second timing difference between uplink component carriers having a same timing advance group; uplink RLC status stall in the UE buffer; uplink MAC-CE stall in the UE buffer; uplink or downlink link imbalance; uplink traffic QoS below a threshold; lack of receipt of an uplink grant in response to a scheduling request transmission transmitted one or more times with a maximum UE transmission power; a first detected or suspected mismatch of a C-DRX between the UE and the network entity detected by the UE; or a second detected or suspected mismatch of an active BWP between the UE and the network entity detected by the UE.

Aspect 3 is the method of any of aspects 1 and 2, further including requesting a connection release that indicates a cause based on the detection of an uplink radio link failure cause value.

Aspect 4 is the method of any of aspects 1-3, further including receiving, in response to requesting the connection release, an indication to transition to a target cell or target frequency to establish the new connection is received from the network entity.

Aspect 5 is the method of any of aspects 1-4, further including initiating a RRC connection reestablish procedure with or without receiving an indication to transition to a target cell or a target frequency.

Aspect 6 is the method of any of aspects 1-5, further includes that the uplink radio link failure report is comprised within a MDT and indicates an uplink radio link failure cause per network request during or after RRC re-establishment.

Aspect 7 is an apparatus for wireless communication at a UE including at least one processor coupled to a memory and at least one transceiver, the at least one processor configured to implement any of Aspects 1-6.

Aspect 8 is an apparatus for wireless communication at a UE including means for implementing any of Aspects 1-6.

Aspect 9 is a computer-readable medium storing computer executable code, where the code when executed by a processor causes the processor to implement any of Aspects 1-6.

Aspect 10 is a method of wireless communication at a network entity comprising communicating with a UE; and receiving a request to release a connection with the UE, the request indicating a cause based on a detection of an uplink radio link failure condition.

Aspect 11 is the method of aspect 10, further includes that the uplink radio link failure condition comprises at least one of duplicated PDSCH retransmissions due to an ACK mis-detected as NACK on uplink; uplink traffic data stall in a UE buffer; transmitting a first timing difference between multiple transmit antennas; transmitting a second timing difference between uplink component carriers having a same timing advance group; uplink RLC status stall in the UE buffer; uplink MAC-CE stall in the UE buffer; uplink or downlink link imbalance; uplink traffic QoS below a threshold; lack of receipt of an uplink grant in response to a scheduling request transmission transmitted one or more times with a maximum UE transmission power; a first detected or suspected mismatch of a C-DRX between the UE and the network entity detected by the UE; or a second detected or suspected mismatch of an active BWP between the UE and the network entity detected by the UE.

Aspect 12 is the method of any of aspects 10 and 11, further including providing, in response to the request to release the connection, an indication for the UE to transition to a target cell or a target frequency to establish a new connection.

Aspect 13 is the method of any of aspects 10-12, further including requesting an uplink radio link failure report based on an uplink radio link failure indication.

Aspect 14 is the method of any of aspects 10-13, further includes that the uplink radio link failure report is comprised within a minimization of drive test (MDT) and indicates an uplink radio link failure cause value.

Aspect 15 is an apparatus for wireless communication at a network entity including at least one processor coupled to a memory and at least one transceiver, the at least one processor configured to implement any of Aspects 10-14.

Aspect 16 is an apparatus for wireless communication at a network entity including means for implementing any of Aspects 10-14.

Aspect 17 is a computer-readable medium storing computer executable code, where the code when executed by a processor causes the processor to implement any of Aspects 10-14.

What is claimed is:

1. An apparatus for wireless communication at a user equipment (UE), comprising:
a memory; and
at least one processor coupled to the memory and, based at least in part on information stored in the memory, the at least one processor is configured to:
monitor for an uplink radio link failure condition between the UE and a network entity;
terminate a connection with the network entity based on a detection of the uplink radio link failure condition;
reestablish a new connection on a same frequency or a different frequency with the network entity or a second network entity; and
transmit an uplink radio link failure report with an uplink failure cause value based on the uplink radio link failure condition.

2. The apparatus of claim 1, further comprising a transceiver coupled to the at least one processor.

3. The apparatus of claim 1, wherein the uplink radio link failure condition comprises at least one of:
duplicated physical downlink shared channel (PDSCH) retransmissions due to an acknowledgement (ACK) mis-detected as non-acknowledgement (NACK) on uplink;
uplink traffic data stall in a UE buffer;
transmit a first timing difference between multiple transmit antennas;
transmit a second timing difference between uplink component carriers having a same timing advance group;
uplink radio link control (RLC) status stall in the UE buffer;
uplink medium access control (MAC) control element (CE) (MAC-CE) stall in the UE buffer;
uplink or downlink link imbalance;
uplink traffic quality of service (QoS) below a threshold;
lack of receipt of an uplink grant in response to a scheduling request transmission transmitted one or more times with a maximum UE transmission power;
a first detected or suspected mismatch of a connected mode discontinuous reception (C-DRX) between the UE and the network entity detected by the UE; or
a second detected or suspected mismatch of an active bandwidth part (BWP) between the UE and the network entity detected by the UE.

4. The apparatus of claim 1, wherein to terminate the connection based on the detection of the uplink radio link failure condition, the at least one processor is configured to:
request a connection release that indicates a cause based on the detection of an uplink radio link failure cause value.

5. The apparatus of claim 4, wherein the at least one processor is configured to:
receive, in response to requesting the connection release, an indication to transition to a target cell or target frequency to establish the new connection is received from the network entity.

6. The apparatus of claim 1, wherein to terminate the connection based on the detection of the uplink radio link failure condition, the at least one processor is configured to:
initiate a radio resource control (RRC) connection reestablish procedure with or without receiving an indication to transition to a target cell or a target frequency.

7. The apparatus of claim 1, wherein the uplink radio link failure report is comprised within a minimization of drive test (MDT) and indicates an uplink radio link failure cause per network request during or after radio resource control (RRC) re-establishment.

8. A method of wireless communication at a user equipment (UE), comprising:
monitoring for an uplink radio link failure condition between the UE and a network entity;
terminating a connection with the network entity based on a detection of the uplink radio link failure condition;
reestablishing a new connection on a same frequency or a different frequency with the network entity or a second network entity; and
transmitting an uplink radio link failure report with an uplink failure cause value based on the uplink radio link failure condition.

9. The method of claim 8, wherein the uplink radio link failure condition comprises at least one of:
duplicated physical downlink shared channel (PDSCH) retransmissions due to an acknowledgement (ACK) mis-detected as non-acknowledgement (NACK) on uplink;
uplink traffic data stall in a UE buffer;
transmit a first timing difference between multiple transmit antennas;
transmit a second timing difference between uplink component carriers having a same timing advance group;
uplink radio link control (RLC) status stall in the UE buffer;
uplink medium access control (MAC) control element (CE) (MAC-CE) stall in the UE buffer;
uplink or downlink link imbalance;
uplink traffic quality of service (QoS) below a threshold;
lack of receipt of an uplink grant in response to a scheduling request transmission transmitted one or more times with a maximum UE transmission power;
a first detected or suspected mismatch of a connected mode discontinuous reception (C-DRX) between the UE and the network entity detected by the UE; or
a second detected or suspected mismatch of an active bandwidth part (BWP) between the UE and the network entity detected by the UE.

10. The method of claim 8, wherein the terminating the connection based on the detection of the uplink radio link failure condition, further comprises:
requesting a connection release that indicates a cause based on the detection of an uplink radio link failure cause value.

11. The method of claim 10, further comprising:
receiving, in response to requesting the connection release, an indication to transition to a target cell or target frequency to establish the new connection is received from the network entity.

12. The method of claim 8, wherein the terminating the connection based on the detection of the uplink radio link failure condition, further comprises:
initiating a radio resource control (RRC) connection reestablish procedure with or without receiving an indication to transition to a target cell or a target frequency.

13. The method of claim 8, wherein the uplink radio link failure report is comprised within a minimization of drive test (MDT) and indicates an uplink radio link failure cause per network request during or after radio resource control (RRC) re-establishment.

14. An apparatus for wireless communication at a network entity, comprising:
a memory; and
at least one processor coupled to the memory and, based at least in part on information stored in the memory, the at least one processor is configured to:
communicate with a user equipment (UE); and
receive a request to release a connection with the UE, the request indicating a cause based on a detection of an uplink radio link failure condition.

15. The apparatus of claim 14, further comprising a transceiver coupled to the at least one processor.

16. The apparatus of claim 14, wherein the uplink radio link failure condition comprises at least one of:
duplicated physical downlink shared channel (PDSCH) retransmissions due to an acknowledgement (ACK) mis-detected as non-acknowledgement (NACK) on uplink;
uplink traffic data stall in a UE buffer;
transmit a first timing difference between multiple transmit antennas;
transmit a second timing difference between uplink component carriers having a same timing advance group;
uplink radio link control (RLC) status stall in the UE buffer;
uplink medium access control (MAC) control element (CE) (MAC-CE) stall in the UE buffer;
uplink or downlink link imbalance;
uplink traffic quality of service (QoS) below a threshold;
lack of receipt of an uplink grant in response to a scheduling request transmission transmitted one or more times with a maximum UE transmission power;
a first detected or suspected mismatch of a connected mode discontinuous reception (C-DRX) between the UE and the network entity detected by the UE; or
a second detected or suspected mismatch of an active bandwidth part (BWP) between the UE and the network entity detected by the UE.

17. The apparatus of claim 14, wherein the at least one processor is configured to:
provide, in response to the request to release the connection, an indication for the UE to transition to a target cell or a target frequency to establish a new connection.

18. The apparatus of claim 14, wherein the at least one processor is configured to:
request an uplink radio link failure report based on an uplink radio link failure indication.

19. The apparatus of claim 18, wherein the uplink radio link failure report is comprised within a minimization of drive test (MDT) and indicates an uplink radio link failure cause value.

20. A method of wireless communication at a network entity, comprising:
communicating with a user equipment (UE); and
receiving a request to release a connection with the UE, the request indicating a cause based on a detection of an uplink radio link failure condition.

21. The method of claim 20, wherein the uplink radio link failure condition comprises at least one of:
duplicated physical downlink shared channel (PDSCH) retransmissions due to an acknowledgement (ACK) mis-detected as non-acknowledgement (NACK) on uplink;
uplink traffic data stall in a UE buffer;
transmit a first timing difference between multiple transmit antennas;
transmit a second timing difference between uplink component carriers having a same timing advance group;
uplink radio link control (RLC) status stall in the UE buffer;
uplink medium access control (MAC) control element (CE) (MAC-CE) stall in the UE buffer;
uplink or downlink link imbalance;
uplink traffic quality of service (QoS) below a threshold;
lack of receipt of an uplink grant in response to a scheduling request transmission transmitted one or more times with a maximum UE transmission power;
a first detected or suspected mismatch of a connected mode discontinuous reception (C-DRX) between the UE and the network entity detected by the UE; or
a second detected or suspected mismatch of an active bandwidth part (BWP) between the UE and the network entity detected by the UE.

22. The method of claim 20, further comprising:
providing, in response to the request to release the connection, an indication for the UE to transition to a target cell or a target frequency to establish a new connection.

23. The method of claim 20, further comprising:
requesting an uplink radio link failure report based on an uplink radio link failure indication.

24. The method of claim 23, wherein the uplink radio link failure report is comprised within a minimization of drive test (MDT) and indicates an uplink radio link failure cause value.
